(19) United States
(12) Patent Application Publication
(10) Pub. No.: US 2015/0063070 A1
(43) Pub. Date: Mar. 5, 2015

(54) ESTIMATING DISTANCES BETWEEN DEVICES

(71) Applicant: Nokia Corporation, Espoo (FI)

(72) Inventor: Juha Petteri Ojanperã, Nokia (FI)

(21) Appl. No.: 14/376,094

(22) PCT Filed: Feb. 9, 2012
(86) PCT No.: PCT/IB2012/050593

§ 371 Date: Oct. 2, 2014

(51) Int. Cl. G01S 11/14

(52) U.S. Cl. CPC G01S 11/14
USPC 367/127; 367/118

(57) ABSTRACT

A mobile recording device comprises means for detecting an audio signal emitted by the first device and means for measuring a strength of the audio signal. A server or the mobile comprises means for using the measured signal strength to estimate a distance between the first and second devices. A server comprises means for storing first and second collections of data sets, each of the data sets of the first collection comprising an emission time stamp, each of the data sets of the second collection comprising a reception time stamp and data indicative of a received signal strength; means for using emission time stamps and reception time stamps of the data sets to identify a data set of the first collection that corresponds to a data set of the second collection; and means for using the data indicative of the signal strength from the identified data set of the second collection to estimate the distance between devices that are sources of the identified data sets.

### FIELD OF THE INVENTION

This invention relates to estimating distances between devices using audio signals.

### BACKGROUND TO THE INVENTION

It is known to distribute devices around an audio space and use them to record an audio scene. Captured signals are transmitted and stored at a rendering location, from where an end user can select a listening point based on their preference from the reconstructed audio space. This type of system presents numerous technical challenges.

In order to create an immersive sound experience, accurate knowledge of the location of audio recording devices is required. This can prove problematic when within a building and unable to retrieve a GPS signal.

### SUMMARY OF THE INVENTION

A first aspect of the invention provides a method of estimating a distance between a first device and a second device, the method comprising the second device:
detecting an audio signal emitted by the first device;
measuring a strength of the audio signal; and
using the measured signal strength to estimate a distance between the first and second devices.

Detecting an audio signal may comprise detecting a sinusoidal audio signal emitted by the first device at a specific frequency.

Detecting a sinusoidal audio signal may comprise detecting using the Goertzel algorithm.

Detecting an audio signal may comprise detecting a tonal signal with a frequency that varies with time.

Detecting an audio signal may comprise detecting an audio signal with tonal content at plural frequencies.

The method may comprise mapping distance to a textual location.

The method may comprise refraining from using the measured signal strength to estimate a distance between the first and second devices when signal strength is below a threshold signal strength.

The method may comprise using measured signal strength from signals transmitted in both directions between the first and second devices to estimate the distance between the devices. This method may comprise using the highest measured signal strength from signals transmitted in both directions between the first and second devices to estimate the distance between the devices.

The method may comprise using the measured signal strength to estimate a distance between the first and second devices may comprise:
storing first and second collections of data sets, each of the data sets of the first collection comprising an emission time stamp, each of the data sets of the second collection comprising a reception time stamp and data indicative of the measured received signal strength;
using emission time stamps and reception time stamps of the data sets to identify a data set of the first collection that corresponds to a data set of the second collection; and
using the data indicative of the signal strength from the identified data set of the second collection to estimate the distance between the first and second devices.

A second aspect of the invention provides apparatus, the apparatus having at least one processor and at least one memory having computer-readable code stored therein which when executed controls the at least one processor to perform a method comprising:
detecting an audio signal emitted by the first device;
measuring a strength of the audio signal; and
   using the measured signal strength to estimate a distance between the first and second devices.

The computer-readable code when executed may control the at least one processor to detect an audio signal, wherein the sinusoidal audio signal emitted by the first device is at a specific frequency.

The computer-readable code when executed may control the at least one processor to detect a sinusoidal audio signal using the Goertzel algorithm.

The computer-readable code when executed may control the at least one processor to detect an audio signal, wherein the audio signal is a tonal signal with a frequency that varies with time.

The computer-readable code when executed may control the at least one processor to detect an audio signal, wherein the audio signal comprises tonal content at plural frequencies.

The computer-readable code when executed may control the at least one processor to map distance to a textual location.

The computer-readable code when executed may control the at least one processor to refrain from using the measured signal strength to estimate a distance between the first and second devices when signal strength is below a threshold signal strength.

The computer-readable code when executed may control the at least one processor to use measured signal strength from signals transmitted in both directions between the first and second devices to estimate the distance between the devices.

The computer-readable code when executed may control the at least one processor to use the highest measured signal strength from signals transmitted in both directions between the first and second devices to estimate the distance between the devices.

The computer-readable code when executed may control the at least one processor to use the measured signal strength to estimate a distance between the first and second devices, further comprising:
storing first and second collections of data sets, each of the data sets of the first collection comprising an emission time stamp, each of the data sets of the second collection comprising a reception time stamp and data indicative of the measured received signal strength;
using emission time stamps and reception time stamps of the data sets to identify a data set of the first collection that corresponds to a data set of the second collection; and
using the data indicative of the signal strength from the identified data set of the second collection to estimate the distance between the first and second devices.

A third aspect of the invention provides a non-transitory computer-readable storage medium having stored thereon computer-readable code, which, when executed by computing apparatus, may cause the computing apparatus to perform a method comprising:
detecting an audio signal emitted by the first device;
measuring a strength of the audio signal; and
   using the measured signal strength to estimate a distance between the first and second devices.

The computer-readable code when executed by computing apparatus may cause the computing apparatus to detect an audio signal emitted by the first device at a specific frequency.

The computer-readable code when executed by computing apparatus may cause the computing apparatus to detect a sinusoidal audio signal using the Goertzel algorithm.

The computer-readable code when executed by computing apparatus may cause the computing apparatus to detect an audio signal comprising a tonal signal with a frequency that varies with time.

The computer-readable code when executed by computing apparatus may cause the computing apparatus to detect an audio signal comprising tonal content at plural frequencies.

The computer-readable code when executed by computing apparatus may cause the computing apparatus to map distance to a textual location.

The computer-readable code when executed by computing apparatus may cause the computing apparatus to refrain from using the measured signal strength to estimate a distance between the first and second devices when signal strength is below a threshold signal strength.

The computer-readable code when executed by computing apparatus may cause the computing apparatus to use measured signal strength from signals transmitted in both directions between the first and second devices to estimate the distance between the devices.

The computer-readable code when executed by computing apparatus may cause the computing apparatus to use the highest measured signal strength from signals transmitted in both directions between the first and second devices to estimate the distance between the devices.

The computer-readable code when executed by computing apparatus may cause the computing apparatus to use the measured signal strength to estimate a distance between the first and second devices may comprise:
storing first and second collections of data sets, each of the data sets of the first collection comprising an emission time stamp, each of the data sets of the second collection comprising a reception time stamp and data indicative of the measured received signal strength;
using emission time stamps and reception time stamps of the data sets to identify a data set of the first collection that corresponds to a data set of the second collection; and
using the data indicative of the signal strength from the identified data set of the second collection to estimate the distance between the first and second devices.

A fourth aspect of the invention provides apparatus comprising:
means for detecting an audio signal emitted by the first device;
means for measuring a strength of the audio signal; and
means for using the measured signal strength to estimate a distance between the first and second devices.

The means for detecting an audio signal may comprise detecting a sinusoidal audio signal emitted by the first device at a specific frequency.

The apparatus may comprise means for detecting a sinusoidal audio signal using the Goertzel algorithm.

The apparatus may comprise means for detecting an audio signal comprising a tonal signal with a frequency that varies with time.

The means for detecting an audio signal may comprise detecting an audio signal with tonal content at plural frequencies.

The apparatus may comprise means for mapping distance to a textual location.

The apparatus may comprise means for refraining from using the measured signal strength to estimate a distance between the first and second devices when signal strength is below a threshold signal strength.

The apparatus may comprise means for using measured signal strength from signals transmitted in both directions between the first and second devices to estimate the distance between the devices.

The apparatus may comprise means for using the highest measured signal strength from signals transmitted in both directions between the first and second devices to estimate the distance between the devices.

The means for using the measured signal strength to estimate a distance between first and second devices may comprise:
storing first and second collections of data sets, each of the data sets of the first collection comprising an emission time stamp, each of the data sets of the second collection comprising a reception time stamp and data indicative of the measured received signal strength;
using emission time stamps and reception time stamps of the data sets to identify a data set of the first collection that corresponds to a data set of the second collection; and
using the data indicative of the signal strength from the identified data set of the second collection to estimate the distance between the first and second devices.

A mobile device may includes at least one processor and at least one memory having computer-readable code stored therein which when executed may control the at least one processor to perform a method comprising:
detecting an audio signal emitted by the first device; and
measuring a strength of the audio signal,
and a server includes at least one processor and at least one memory having computer-readable code stored therein which when executed may control the at least one processor to perform using the measured signal strength to estimate a distance between the first and second devices.

A mobile device may comprise the means for detecting an audio signal emitted by the first device and the means for measuring a strength of the audio signal and a server device may comprise the means for using the measured signal strength to estimate a distance between the first and second devices.

A fifth aspect of the invention comprises a method comprising:
storing first and second collections of data sets, each of the data sets of the first collection comprising an emission time stamp, each of the data sets of the second collection comprising a reception time stamp and data indicative of a received signal strength;
using emission time stamps and reception time stamps of the data sets to identify a data set of the first collection that corresponds to a data set of the second collection; and
using the data indicative of the signal strength from the identified data set of the second collection to estimate the distance between devices that are sources of the identified data sets.

The method may comprise using data indicating an emission frequency in the emission data sets and data indicating a reception frequency in the reception data sets along with the emission time stamps and reception time stamps of the data sets to identify a data set of the first collection that corresponds to a data set of the second collection.

The method may comprise using data sets relating to signals transmitted in both directions between the devices that are the sources of the identified data sets to estimate the distance between the devices.

The method may comprise using the highest measured signal strength from sinusoidal signals transmitted in both directions between the devices that are the sources of the identified data sets to estimate the distance between the devices.

The method may comprise mapping distances to a textual location.

The method may comprise using clock correction information to adjust time stamps when identifying the data set of the first collection that corresponds to the data set of the second collection.

The invention also provides a computer program comprising instructions that when executed by computer apparatus control it to perform any method above.

A sixth aspect of the invention provides apparatus, the apparatus having at least one processor and at least one memory having computer-readable code stored therein which when executed may control the at least one processor to perform a method comprising:
storing first and second collections of data sets, each of the data sets of the first collection comprising an emission time stamp, each of the data sets of the second collection comprising a reception time stamp and data indicative of a received signal strength;
using emission time stamps and reception time stamps of the data sets to identify a data set of the first collection that corresponds to a data set of the second collection; and
using the data indicative of the signal strength from the identified data set of the second collection to estimate the distance between devices that are sources of the identified data sets.

The computer-readable code when executed may control the at least one processor to use data indicating an emission frequency in the emission data sets and data indicating a reception frequency in the reception data sets along with the emission time stamps and reception time stamps of the data sets to identify a data set of the first collection that corresponds to a data set of the second collection.

The computer-readable code when executed may control the at least one processor to use data sets relating to signals transmitted in both directions between the devices that are the sources of the identified data sets to estimate the distance between the devices.

The computer-readable code when executed may control the at least one processor to use the highest measured signal strength from sinusoidal signals transmitted in both directions between the devices that are the sources of the identified data sets to estimate the distance between the devices.

The computer-readable code when executed may control the at least one processor to map distances to a textual location.

The computer-readable code when executed may control the at least one processor to use clock correction information to adjust time stamps when identifying the data set of the first collection that corresponds to the data set of the second collection.

A seventh aspect of the invention provides a non-transitory computer-readable storage medium having stored thereon computer-readable code, which, when executed by computing apparatus, may cause the computing apparatus to perform a method comprising:
storing first and second collections of data sets, each of the data sets of the first collection comprising an emission time stamp, each of the data sets of the second collection comprising a reception time stamp and data indicative of a received signal strength;
using emission time stamps and reception time stamps of the data sets to identify a data set of the first collection that corresponds to a data set of the second collection; and
using the data indicative of the signal strength from the identified data set of the second collection to estimate the distance between devices that are sources of the identified data sets.

The computer-readable code when executed by computing apparatus may cause the computing apparatus to using data indicating an emission frequency in the emission data sets and data indicating a reception frequency in the reception data sets along with the emission time stamps and reception time stamps of the data sets to identify a data set of the first collection that corresponds to a data set of the second collection.

The computer-readable code when executed by computing apparatus may cause the computing apparatus to use data sets relating to signals transmitted in both directions between the devices that are the sources of the identified data sets to estimate the distance between the devices.

The computer-readable code when executed by computing apparatus may cause the computing apparatus to use the highest measured signal strength from sinusoidal signals transmitted in both directions between the devices that are the sources of the identified data sets to estimate the distance between the devices.

The computer-readable code when executed by computing apparatus may cause the computing apparatus to map distances to a textual location.

The computer-readable code when executed by computing apparatus may cause the computing apparatus to use clock correction information to adjust time stamps when identifying the data set of the first collection that corresponds to the data set of the second collection.

An eighth aspect of the invention provides apparatus comprising:
means for storing first and second collections of data sets, each of the data sets of the first collection comprising an emission time stamp, each of the data sets of the second collection comprising a reception time stamp and data indicative of a received signal strength;
means for using emission time stamps and reception time stamps of the data sets to identify a data set of the first collection that corresponds to a data set of the second collection; and
means for using the data indicative of the signal strength from the identified data set of the second collection to estimate the distance between devices that are sources of the identified data sets.

The apparatus may comprise means for using data indicating an emission frequency in the emission data sets and data indicating a reception frequency in the reception data sets along with the emission time stamps and reception time stamps of the data sets to identify a data set of the first collection that corresponds to a data set of the second collection.

The apparatus may comprise means for using data sets relating to signals transmitted in both directions between the devices that are the sources of the identified data sets to estimate the distance between the devices.

The apparatus may comprise means for using the highest measured signal strength from sinusoidal signals transmitted in both directions between the devices that are the sources of the identified data sets to estimate the distance between the devices.

The apparatus may comprise means for mapping distances to a textual location.

The apparatus may comprise means for using clock correction information to adjust time stamps when identifying the data set of the first collection that corresponds to the data set of the second collection.

Embodiments of the invention will now be described, by way of example only, with reference to the accompanying drawings.

### BRIEF DESCRIPTION OF THE DRAWINGS

FIG. 1 shows audio scene with N capturing devices;

FIG. 2 is a Nock diagram of an end-to-end system embodying aspects of the invention;

FIG. 3 shows details of some components of the FIG. 2 system according to some embodiments;

FIG. 4 shows details of data sets stored in the FIG. 2 system;

FIG. 5 shows a high level flowchart illustrating operation of some of the embodiments FIG. 3; and

FIG. 6 shows details of some components of the FIG. 2 system according to some other embodiments;

FIG. 7 shows a high level flowchart illustrating operation of some of the embodiments in FIG. 6.

### DETAILED DESCRIPTION OF EMBODIMENTS

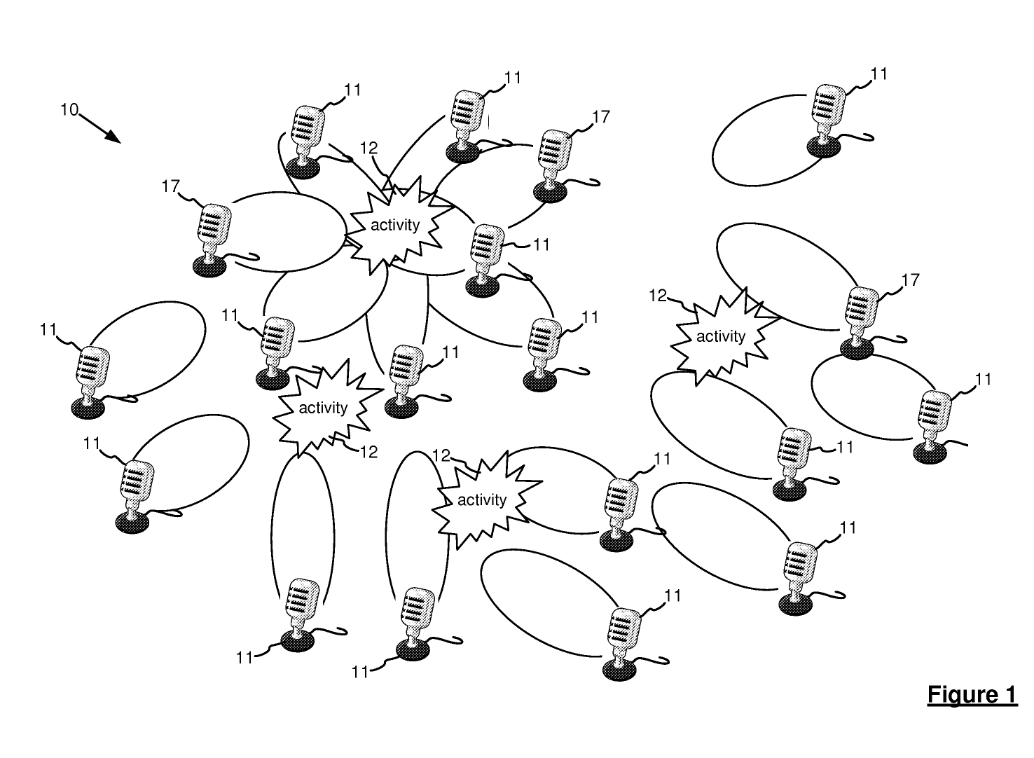

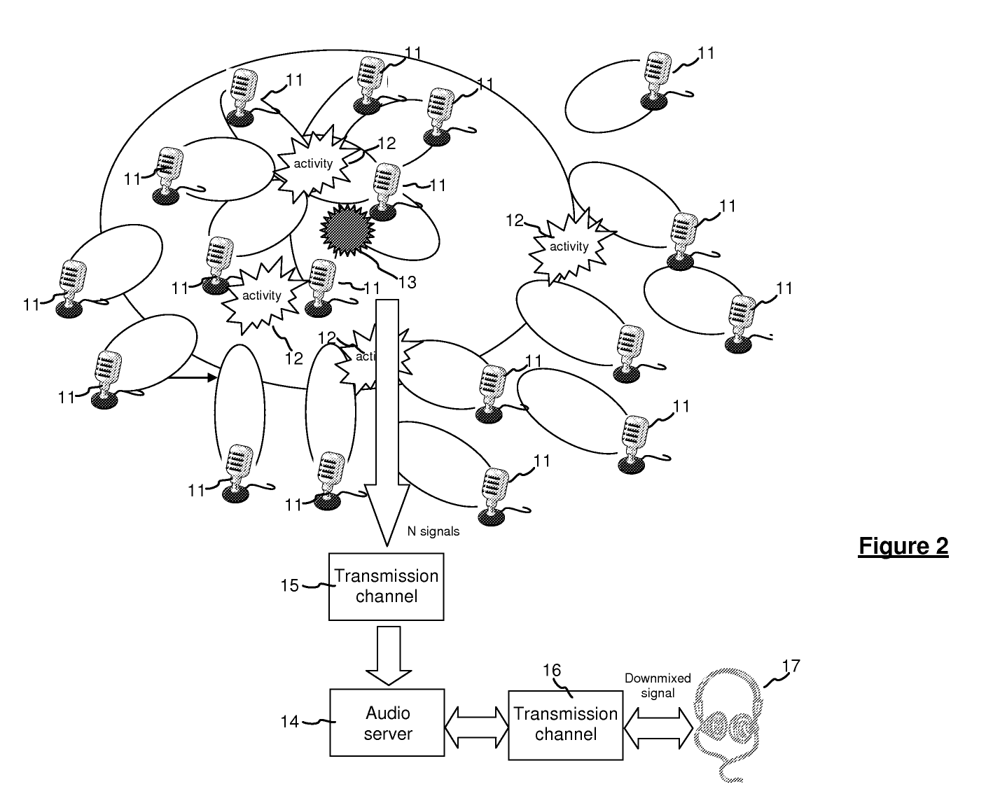

FIGS. 1 and 2 illustrate a system in which embodiments of the invention can be implemented. A system 10 consists of N devices 11, 17 that are arbitrarily positioned within the audio space to record an audio scene. In these Figures, there are shown four areas of audio activity 12. The captured signals are then transmitted (or alternatively stored for later consumption) so an end user can select a listening point 13 based on his/her preference from a reconstructed audio space. A rendering part then provides one or more downmixed signals from the multiple recordings that correspond to the selected listening point. In FIG. 1, microphones of the devices 11 are shown to have highly directional beam, but embodiments of the invention use microphones having any form of directional sensitivity, which includes omni-directional microphones with little or no directional sensitivity at all. Furthermore, the microphones do not necessarily employ a similar beam, but microphones with different beams may be used. The downmixed signal(s) may be a mono, stereo, binaural signal or may consist of more than two channels, for instance four or six channels.

In an end-to-end system context, the framework operates as follows. Each recording device 11 records the audio scene and uploads/upstreams (either in real-time or non real-time) the recorded content to an audio server 14 via a channel 15. The upload/upstream process provides also positioning information about where the audio is being recorded and the recording direction/orientation. A recording device 11 may record one or more audio signals. If a recording device 11 records (and provides) more than one signal, the direction/orientation of these signals may be different. The position information may be obtained, for example, using GPS coordinates, Cell-ID or A-GPS. Recording direction/orientation may be obtained, for example, using compass, accelerometer or gyroscope information.

Ideally, there are many users/devices 11, 17 recording an audio scene at different positions but in close proximity. The server 14 receives each uploaded signal and keeps track of the positions and the associated directions/orientations.

Initially, the audio scene server 14 may provide high level coordinates, which correspond to locations where user uploaded/upstreamed content is available for listening, to an end user device 11, 17. These high level coordinates may be provided, for example, as a map to the end user device 11, 17 for selection of the listening position. The end user device 11, 17 or e.g. an application used by the end user device 11, 17 is has functions of determining the listening position and sending this information to the audio scene server 14. Finally, the audio scene server 14 transmits the downmixed signal corresponding to the specified location to the end user device 11, 17. Alternatively, the audio server 14 may provide a selected set of downmixed signals that correspond to listening point and the end user device 17 selects the downmixed signal to which he/she wants to listen. Furthermore, a media format encapsulating the signals or a set of signals may be formed and transmitted to the end user devices 17.

Embodiments of this specification relates to immersive person-to-person communication including also video and possibly synthetic content. Maturing 3D audio-visual rendering and capture technology facilitates a new dimension of natural communication. An ‘all-3D’ experience is created that brings a rich experience to users and brings opportunity to businesses through novel product categories.

To be able to provide compelling user experience for the end user, the multi-user content itself must be rich in nature. The richness typically means that the content is captured from various positions and recording angles. The richness can then be translated into compelling composition content where content from various users are used to re-create the timeline of the event from which the content was captured. In order to achieve accurate rendering of this rich 3D content, accurate positions of the sound recording devices must be recorded. It is an aim of embodiments of this specification to provide a mechanism for allowing establishment of accurate locations of devices, even when a GPS signal cannot be detected, for example in an indoor environment.

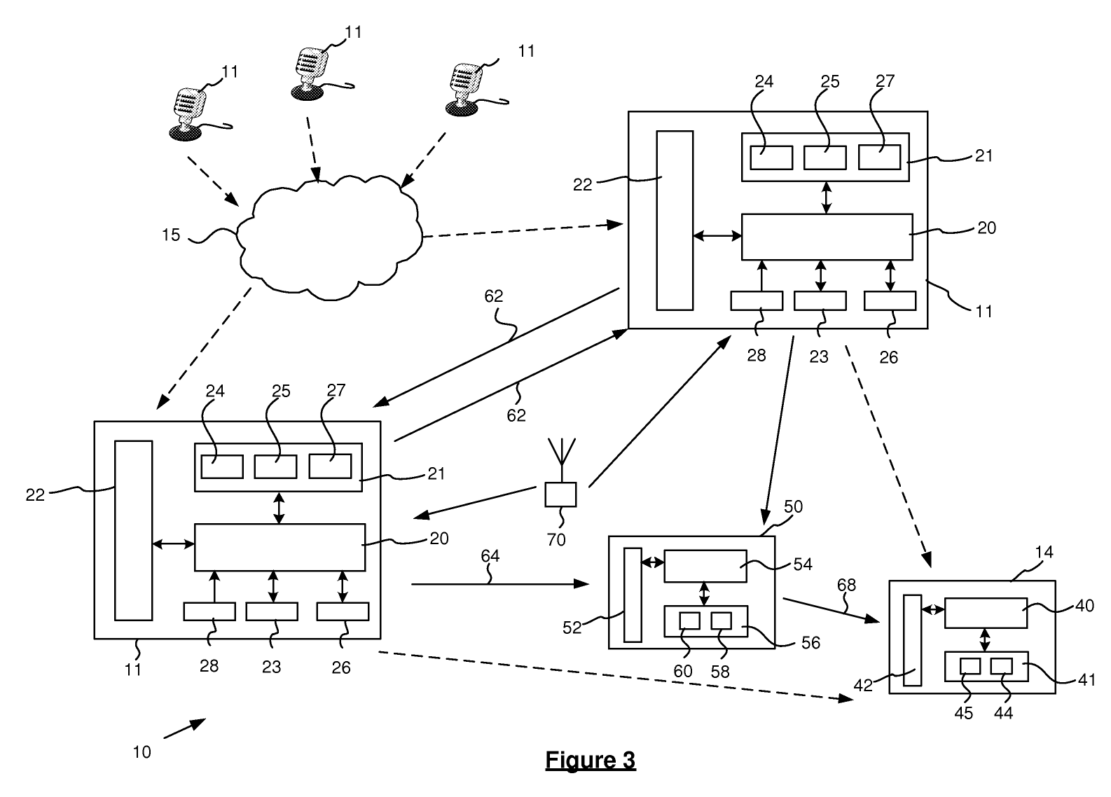

FIG. 3 shows a schematic Nock diagram of a system 10 according to embodiments of the invention. Reference numerals are retained from FIGS. 1 and 2 for like elements.

In FIG. 3, multiple end user recording devices 11 are connected to an audio server 14 by a first transmission channel or network 15. The user devices 11 are further connected to a network server 50. The user devices 11 are used for detecting an audio scene for recording. The user devices 11 may record audio and store it locally for uploading later. Alternatively, they may transmit the audio in real time, in which case they may or may not also store a local copy. The user devices 11 are referred to as recording devices 11 because they record audio, although they may not permanently store the audio locally.

The user devices 11 are also configured to emit a sinusoidal proximity signal 62 when controlled to do so. The proximity signal 62 is emitted from a loudspeaker 26 within the user device 11. In an exemplary embodiment, the proximity signal 62 consists of largely inaudible beacon signals, for example sinusoidal beacon signals of between 16 kHz and 20 kHz. In alternative embodiments, the proximity signal 62 is an audible beacon signal. The user devices 11 are also configured to detect the proximity signal 62. The proximity signal 62 is detected by the microphone 23 within the user devices 11.

Each of the recording devices 11 is a communications device equipped with a microphone 23 and loudspeaker 26. Each device 11 may for instance be a mobile phone, smartphone, laptop computer, tablet computer, PDA, personal music player, video camera, stills camera or dedicated audio recording device, for instance a dictaphone or the like.

The recording device 11 includes a number of components including a processor 20 and a memory 21. The processor 20 and the memory 21 are connected to the outside world by an interface 22. The interface 22 is capable of transmitting and receiving according to multiple communication protocols. For example, the interface may be configured to transmit and receive according to one or more of the following: wired communication, Bluetooth, WiFi, and cellular radio. Suitable cellular protocols include GSM, GPRS, 3G, HSXPA, LTE, CMDA etc. At least one microphone 23 is connected to the processor 20. The microphone 23 is to some extent directional. If there are multiple microphones 23, they may have different orientations of sensitivity. The processor is also connected to a loudspeaker 26.

The processor is further connected to a timing device 28, which here is a clock. The clock 28 maintains its accuracy using timing signals transmitted by a base station 70 of a mobile telephone network. The clock 28 may alternatively be maintained in some other way.

The memory 21 may be a non-volatile memory such as read only memory (ROM) a hard disk drive (HDD) or a solid state drive (SSD). The memory 21 stores, amongst other things, an operating system 24, at least one software application 25, and one or more data sets 27.

Wherein the user device 11 is acting as a proximity signal 62 emitter, the data set 27 comprises emitted sound parameters. Wherein the user device 11 is acting as a proximity signal 62 receiver, the data set 27 comprises proximity detection results. The data sets 27 are transmitted to the network server 50 over a channel 64. The data sets 27 may be transmitted by any available communications means, for example, WiFi, Bluetooth, or GPRS.

The memory 21 is used for the temporary storage of data as well as permanent storage. Alternatively, there may be separate memories for temporary and non-temporary storage, such as RAM and ROM. The operating system 24 may contain code which, when executed by the processor 20 in conjunction with the memory 25, controls operation of each of the hardware components of the device 11.

The one or more software applications 25 and the operating system 24 together cause the processor 20 to operate in such a way as to achieve required functions.

In this case, the functions include processing audio data, and may include recording it. As is explained below, the functions include handling proximity audio signals.

The network server 50 is further connected to the audio server 14. The network server 50 is configured to transmit proximity analysis information 66, including location information and/or distance information, to the audio server 14. The network server 50 includes a processor 54, a memory 56 and an interface 52. Within the memory 56 are stored an operating system 58 and one or more software applications 60.

The memory 56 may be a non-volatile memory such as read only memory (ROM) a hard disk drive (HDD) or a solid state drive (SSD). The memory 56 stores, amongst other things, an operating system 58 and at least one software application 60. The memory 56 is used for the temporary storage of data as well as permanent storage. Alternatively, there may be separate memories for temporary and non-temporary storage, e.g. RAM and ROM. The operating system 58 may contain code which, when executed by the processor 54 in conjunction with the memory 56, controls operation of each of the hardware components of the server 50.

The one or more software applications 60 and the operating system 58 together cause the processor 54 to operate in such a way as to achieve required functions. In this case, the functions include processing received data logs to derive distances between different devices 11. The distance between devices 11, or the proximity analysis, is transmitted to the audio server 14 over a channel 68.

The audio server 14 includes a processor 40, a memory 41 and an interface 42. The interface 42 may receive and send data sets to and from the recording devices 11 by way of intermediary components or networks. Within the memory 41 are stored an operating system 44 and one or more software applications 45.

The memory 41 may be a non-volatile memory such as read only memory (ROM) a hard disk drive (HDD) or a solid state drive (SSD). The memory 41 stores, amongst other things, an operating system 44 and at least one software application 45. The memory 41 is used for the temporary storage of data as well as permanent storage. Alternatively, there may be separate memories for temporary and non-temporary storage, e.g. RAM and ROM. The operating system 44 may contain code which, when executed by the processor 40 in conjunction with the memory 45, controls operation of each of the hardware components of the server 44.

The one or more software applications 45 and the operating system 44 together cause the processor 40 to operate in such a way as to achieve required functions.

Each of the user devices 11, the audio server 14 and the network server 50 operate according to the operating system and software applications that are stored in the respective memories thereof. Where in the following one of these devices is said to achieve a certain operation or provide a certain function, this is achieved by the software and/or the operating system stored in the memories unless otherwise stated.

Audio recorded by a recording device 11 is a time-varying series of data. The audio may be represented in raw form, as samples. Alternatively, it may be represented in a non-compressed format or compressed format, for instance as provided by a codec. The choice of codec for a particular implementation of the system may depend on a number of factors. Suitable codecs may include codecs that operate according to audio interchange file format, pulse-density modulation, pulse-amplitude modulation, direct stream transfer, or free lossless audio coding or any of a number of other coding principles. Coded audio represents a time-varying series of data in some form.

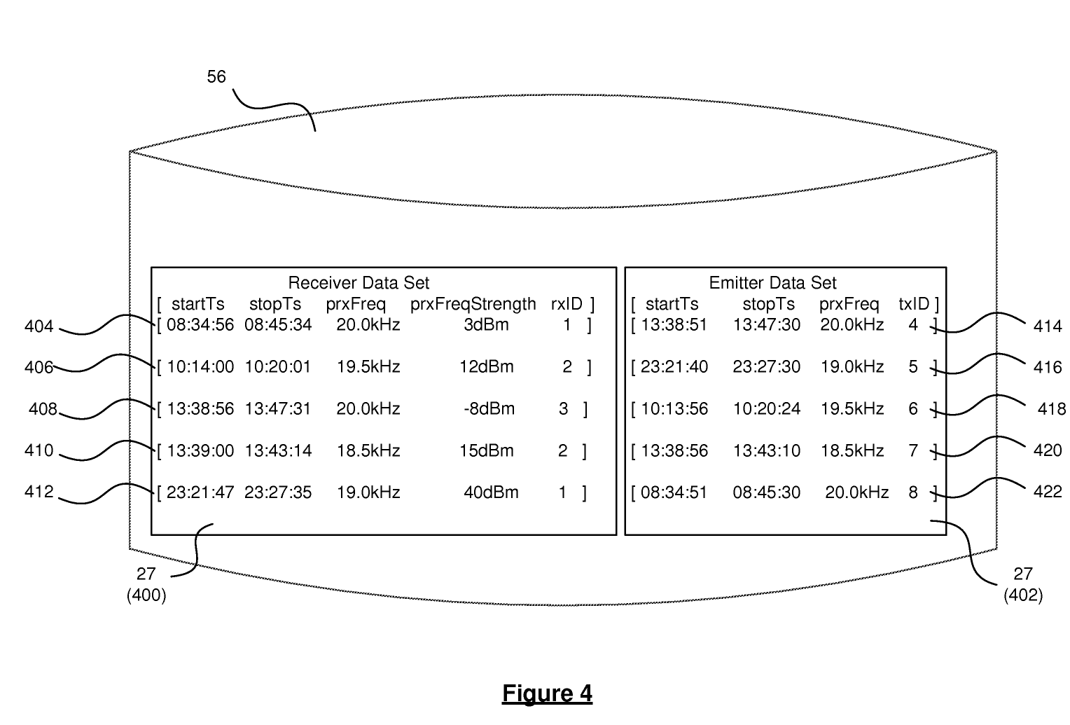

The data sets 27 will now be described with reference to FIG. 4. Data set storage module 56 stores two collections of data sets 27. One collection comprises plural emission data sets 402 and the other collection comprises plural reception data sets 400.

In the case of an emitter data set collection 402, the data included in the data set comprises: the time at which transmission of the proximity signal began; the time at which transmission of the proximity signal ended; the proximity signal frequency; and the identity of the emitter 11.

In the case of a receiver data set collection 400, the data comprises: the time at which reception of the proximity signal began; the time at which reception of the proximity signal ended; the proximity signal frequency; the measured proximity signal strength; and the identity of the receiver.

The collection of data sets 27 comprise multiple data sets 404-422. Each emitter data set can be matched to a respective receiver data set. In this example, data set 404 is matched to data set 422; data set 406 is matched to data set 418; data set 408 is matched to data set 414; data set 410 is matched to data set 420; and data set 412 is matched to data set 416. Data sets are matched using time stamps and proximity signal frequency. Matched receivers and emitters are linked using their respective identifiers. An identifier may be any value unique or pseudo-unique to the user device 11. This may be a MAC address, IMSI, IP or other network address, or a simple integer.

Proximity signal strength is expressed in Decibels (dB or dBm), although it may instead be expressed with some other suitable measure. A low signal strength can be used to determine that a receiver is a relatively large distance from the transmitter, for example pairing 408 and 414. A high signal strength can be used to determine that a receiver is a relatively small distance from the transmitter, for example pairing 412 and 416.

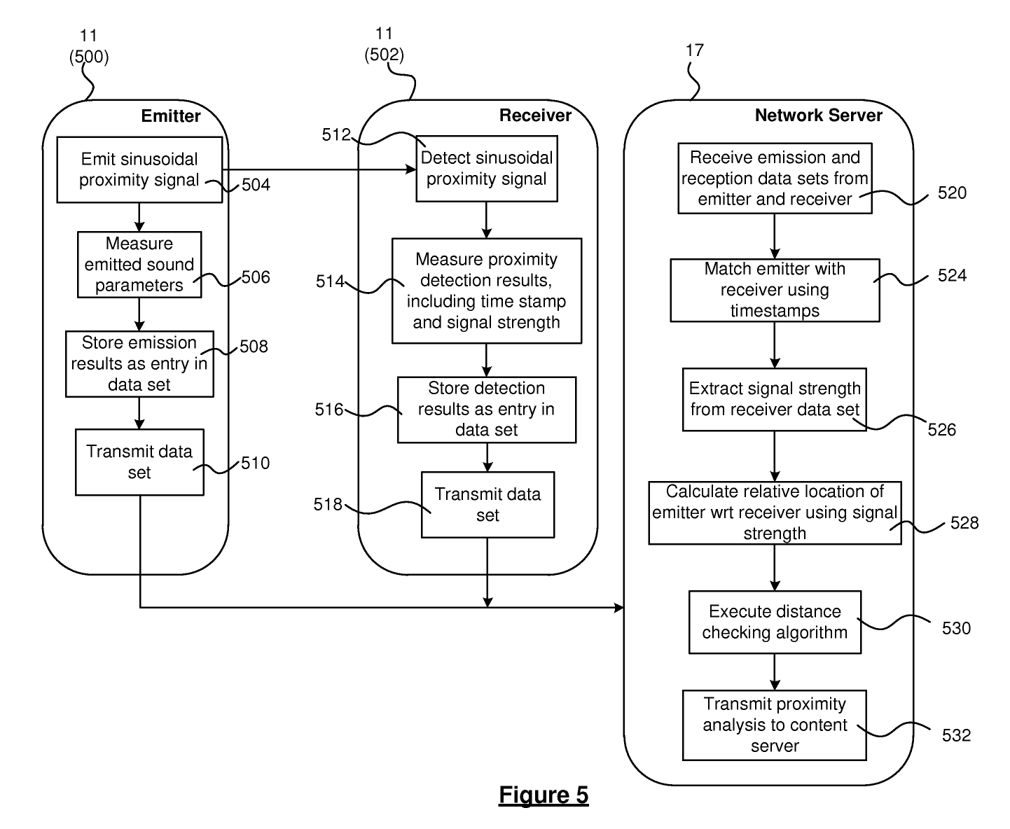

FIG. 5 shows a high level exemplary block diagram of the operation of user devices 11 and a network server 17 according to some embodiments of the invention. In the figure, the system is shown to include first and second user devices 11, and a network server 17. The first user device 11 performs as a proximity signal emitter, and the second user device 11 performs as a proximity signal receiver, herein labelled 500 and 502 respectively. Both devices capture the audio or audio and video content of a scene continuously.

First, in step 504 the emitter 500 emits a sinusoidal proximity signal from its loudspeaker 26. In some embodiments, emission of the proximity signal occurs automatically, in any suitable way. In alternative embodiments, a further server (not shown) triggers the emission from devices that are subscribed to the server when the server detects there are sufficient user devices 11 in the venue. Emission typically lasts for several seconds and can be repeated for several tens of seconds to increase the robustness of the detection. In one embodiment, the proximity signal is of largely inaudible frequency, for example between 16 kHz and 20 kHz. Alternatively, the proximity signal may be of an audible frequency.

The emitting device 500 then records parameters associated with the emitted signal. These parameters include: a time at which the proximity signal was sent from the emitter; a time at which the emitter stopped emitting the proximity signal, the frequency of the proximity signal; and an identifier. Each group of four parameters is known as a data set 414. A group of data sets is defined as a collection 402.

Time is measured in each of the recording devices 11 using the clock 28 present in that device 11. The clock 28 is kept up to date using Network Time Protocol (NTP) stamps from the base station 70. In a further embodiment, time stamps are exchanged locally using adhoc networking. In this embodiment, all devices in the space first signal their local time stamp and one of the time stamps (also signalled to the other devices) is used as a reference in the data set.

In further embodiments, there is no synchronisation of the clocks in the recording devices. In these embodiments, the data sets 27 include timestamps that reflect local time at the device 11 that is the source of the data set. The recording devices 11 are configured to include time stamps in the audio recordings, the time stamps relating to specific moments in the recorded audio. The audio server 14 is configured to identify how to align the recorded audio tracks, and from this and the time stamps calculates differences between the clocks in the recording devices 11. Information relating to the clocks of the audio devices 11 is then sent from the audio server 14 to the network server 17. The network server 17 uses received clock information to amend data sets 27 so as to ensure that the time stamps included in those data sets 27 are accurate with regard to the time stamps included in other data sets. Put another way, the network server 17 provides alignment between the time stamps included in the data sets 27 and a reference. Put yet another way, the network server 17 provides post-time stamp generation synchronisation. The clocks in the recording devices 11 are not affected.

Post filtering is applied to the data set 502 in order to filter out small deviations in the time stamps. If two data sets with high proximity signal strength are detected with a relatively small difference between the corresponding timestamps, the two data sets are merged into one data set. This can be achieved by deleting or disregarding one data set. This reduces the number of data sets which will later be transmitted to the network server 17. This can be carried out without significantly impacting operation because high signal strengths indicates devices that are close together, and nearby devices are less useful in providing a rich audio scene representation than are devices that are further away.

In step 510, the emitter transmits its data set collection 402 to the network server 17 after a predetermined period of time. In an alternative embodiment the data set is transmitted after a predetermined number of entries have been stored.

At step 512, the receiver receives the sinusoidal proximity signal. In some embodiments, the sinusoidal proximity signal is differentiated from noise by use of the Goertzel algorithm. In further embodiments, bandpass filters are used to detect the proximity signals and their strength at particular frequencies.

At step 514, parameters associated with the received proximity signal are measured. These parameters include: the time at which the proximity signal was begun to be received by the receiver; the time at which the receiver stopped receiving the proximity signal; the frequency of the received proximity signal; and a measured signal strength of the proximity signal. As with the emitter 500, each group of parameters are stored as a data set 404 within a collection 400. The method of signal measurement is described in detail below.

For a 19 kHz proximity signal, the signal values that correspond to 18.5 kHz, 19 kHz, and 19.5 kHz are first calculated using the Goertzel algorithm. Next, the proximity signal strength is determined according to equation 1, as follows:

$$prxFreqStrength = 10 \cdot {log}_{10} ( \frac{1 + 2 \cdot {gf}_{19 kHz}}{{gf}_{18.5 kHz} + {gf}_{19.5 kHz}} ) \qquad ( 1 )$$

where gf_{fkHZ} describes the signal value for the f^{th} frequency component. Equation 1 is calculated for certain time intervals. In one embodiment, these time intervals may be every 0.5 s. The resulting value needs to be applied to a limiter to make sure that a background noise is not detected as proximity signal. The limiter is according to:

$$prxFreqStrengthFlag = \{ \begin{matrix}present , & prxFreqStrength > PRX\_THR \\ not\_present , & otherwise\end{matrix} \qquad ( 2 )$$

where PRX_THR describes the threshold value. In some embodiments, this value is 20. If Equation 2 returns “present”, a data set is written.

In step 518, the receiver transmits its data set 500 to the network server 17 after a predetermined period of time, for example 10 minutes. In an alternative embodiment the data set is transmitted after a predetermined number of entries have been stored.

The data sets 27 are received from user devices 11 by the network server 17 in step 520. The data sets 27 are collected and stored in memory 56. Next, data sets 27 within the memory 56 are matched. In these embodiments, matching is achieved using the time stamps. If a reception data set has timestamps that match timestamps of an emission data set, and the data sets indicate the same frequency, then the data sets can be said to be a pair. Matching of timestamps can be achieved in any suitable way. For instance, timestamps can be said to be matched if both start and end time stamps are within a certain separation, for example 2 seconds. An acceptable separation may be dependent on the technique used for synchronisation of clocks in the devices; if the clocks can be assumed to be closely matched, then a lower separation threshold may be used.

Once a pair of data sets has been matched, the distance between the corresponding devices is calculated using the signal strength within the appropriate reception data set. The signal strength is indicative of distance between the devices because loudness of the received signal decreases with distance from the emitter in a ‘distance squared’ relationship.

The procedure for calculating the distance and matching devices is as follows:

| | |
|---|---|
| 1 | TK = max(T,K) |
| 2 | dtx is TK x TK matrix with zero valued elements |
| 3 | For each t in {1, . . . , T} |
| 4 | For each k in {1, . . . , K} |
| 5 | t = o |
| 6 | tRef = o |
| 7 | prxVal = {} |
| 8 | For each rk in {1, . . . , N} |
| 9 | Find fI from LogTXₜ where |
| | LogTXₜ.startTS_{fI} >= LogRXₖ.startTSᵣₖ and |
| | LogTXₜ.endTS_{fI} < LogRXₖ.startTSᵣₖ set startTS = LogRXₖ.startTSᵣₖ |
| | Or |
| | LogRXₖ.endTSᵣₖ <= LogTXₜ.endTS_{fI} and |
| | LogRXₖ.endTSᵣₖ >= LogTXₜ.startTS_{fI} set startTS = LogTXₜ.startTS_{fI} |
| 10 | If LogTXₜ.prxFreq_{fI} == LogRXₖ.prxFreqᵣₖ |
| 11 | endTS = min (LogTXₜ.endTS_{fI},LogRXₖ.endTSᵣₖ) |
| 12 | t = t + (endTS − startTS) |
| 13 | prxVal.append(LogRXₖ.prxFreqStrengthᵣₖ) |
| 14 | tRef = tRef + (LogTXₜ.endTS_{fI} − LogTXₜ.startTS_{fI}) |
| 15 | |
| 16 | $If \frac{t}{tRef} > PRX\_TIME \_THR$ |
| 17 | dtx_{t,k} = mean(prxVal) |

Lines 1-2 create an empty matrix dtx which describes the distance between the devices in the space. Line 9 determines the index for the data set that is overlapping with the emitter. A check is made whether the detection occurred after the emission started (first part of the line 9; before ‘or’) or detection occurred before emission but the end of the proximity detection is within emission (second part of the line 9; after ‘or’). As the time stamps may not be accurate (the actual difference may be tens of milliseconds) it is possible that detection occurs slightly before the emission in terms of the stamps. Line 10 checks that the proximity frequency matches that of the receiver and transmitter. Line 12 increases the variable that indicates the amount of time where match between receiver and transmitter was found. Line 13 appends the strength of the proximity detection to the vector prxVal. Line 14 increases the variable that indicates the amount of time when the receiver is emitting. Next, line 16 checks that the receiver was able to detect the emitter for at least a certain time period when the transmitter was emitting. t describes the duration for which the receiver was able to detect the emission, and tRef describes the duration for which the emitter was emitting. The value for PRX_TIME_THR is implementation dependent but, for example, 0.5 might be enough. In this case, the receiver should detect the transmitter for at least half of the time when the emitter was active. This step increases the robustness of the detection. For example, if receiver was able to detect the emission only for a short duration then it can be inferred that the detection is not reliable and should be excluded from further processing. Finally, line 17 determines the distance value for the receiver and transmitter from the strength values. In the current implementation, this value is the mean value of the detection results. In other embodiments the value could be based on other metrics such as maximum or median value.

Next, in step 530, the distance results are post-processed to verify that distance from one device 11 to the other is available in both directions (e.g. from a to b and from b to a) according to:

| | |
|---|---|
| 1 | For i = 1 to TK |

| | |
|---|---|
| 2 | For j = i+1 to TK |

| | |
|---|---|
| 3 | If dtx_{i,j} > 0 or dtx_{j,i} > 0 |

| | |
|---|---|
| 4 | If dtx_{i,j} > 0 |

| | |
|---|---|
| 5 | dtx_{i,j} = dtx_{j,i} |

| | |
|---|---|
| 6 | Else if dtx_{j,i} > 0 |

| | |
|---|---|
| 7 | dtx_{j,i} = dtx_{i,j} |

| | |
|---|---|
| 8 | Else |

| | |
|---|---|
| 9 | dtx_{i,j} = max(dtx_{i,j}, dtx_{j,i}) |
| | dtx_{j,i} = dtx_{i,j} |

Line 3 checks that distances are available at least to one direction between the devices. Lines 4-9 then determine the distance also to the other direction. If distance exists in both directions, the greatest distance is used for both directions, in line 9.

Estimated distance to the receiving device from the emitting device is then used by the network server 17 to estimate the location of the receiving device. Triangulation may be used to locate user devices within a specific frame of reference. For example, if the distance to a first device is known by several devices with known location, then location of the first device can be estimated. Location of devices may be known through any available means, such as WiFi detectors, RFID beacons, or GPS receivers (not shown).

Calculating the distance in both directions between the devices can mitigate errors in distance estimation that may occur through the use of directional microphones that are not oriented optimally, directional speakers that are not oriented optimally and/or blocking of a microphone or speaker, for instance by a user's finger.

In some embodiments, location mapping may be implemented as part of the post-processing procedure. Location mapping based on determined proximity strength values or based on some global proximity strength values can be determined as follows. For example, for nMapPositions relative location positions the following mapping steps can be performed:

$$nSteps = \frac{( maxPrxStrength - minPrxStrength )}{nMapPositions} \qquad ( 3 )$$

where maxPrxStrength and minPrxStrength are the maximum and minimum valid values in matrix dtx, respectively. In this case, the strength values are based on values specific to the local space. Furthermore,

$$prxStrengthPos = [ \begin{matrix}maxPrxStrength - nSteps \\ maxPrxStrength - 2 \cdot nSteps \\ … \\ maxPrxStrength - nMapPositions \cdot nSteps\end{matrix} ] \qquad ( 4 )$$

Assuming three relative locations: Close, Medium and Far, the textual locations are therefore according to:

prxStrengthMap=[Close,Medium,Far] (5)

| | |
|---|---|
| 1 | dxtPos{1,...,TK}{1,...,TK} = Unknown |
| 2 | For i = 1 to TK |

| | |
|---|---|
| 3 | For j = 1 to TK |

| | |
|---|---|
| 4 | If dtx_{i,j} > 0 |

| | |
|---|---|
| 5 | For k = o to nMapPositions |

| | |
|---|---|
| 6 | If dtx_{i,j} ≧ prxStrengthPos[k] |

| | |
|---|---|
| 7 | dtxPos_{i,j} = prxStrengthMap[k] |

In step 632, the calculated location information is transmitted to the content server 14.

In some embodiments the content server 14 applies the distance information dtx and also dtxPos such that various content composition mixtures provide enhanced experience. The selection pattern for the downmixed signal(s) may, for example, follow some pre-defined pattern such as Close, Medium, Far, Far, Medium, Close; or Close, Far, Close, Medium, Close, Far, Medium, Close.

Finally, a user requests from the content server 14 a localised audio recording of the scene.

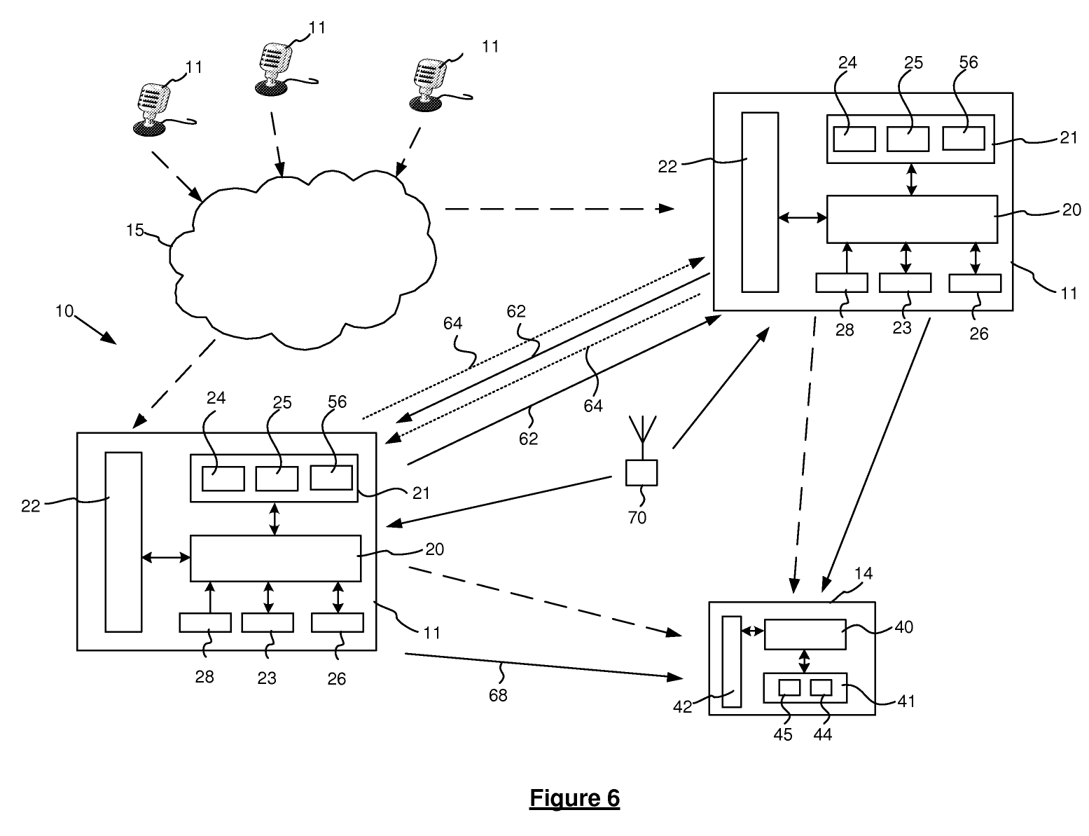

FIG. 6 shows a schematic block diagram of a system 10 according to an alternative embodiment of the invention. Reference numerals are retained from FIGS. 1, 2 and 3 for like elements.

In this embodiment, the network server 50 is incorporated into a user device 11. In this embodiment, the proximity signal emitting device 11 transmits an emission data set 27 to the proximity signal receiving device 11 over the channel 64. The data set 27 may be transmitted by any available communications means, for example, WiFi, Bluetooth, or cellular radio. The proximity signal receiving device 11 calculates the distance between itself and the proximity signal emitting device 11. The resulting proximity analysis is transmitted to the audio server 14 over a channel 68. The device 11 memory 21 comprises a module 56 capable of storing a collection of data sets 27.

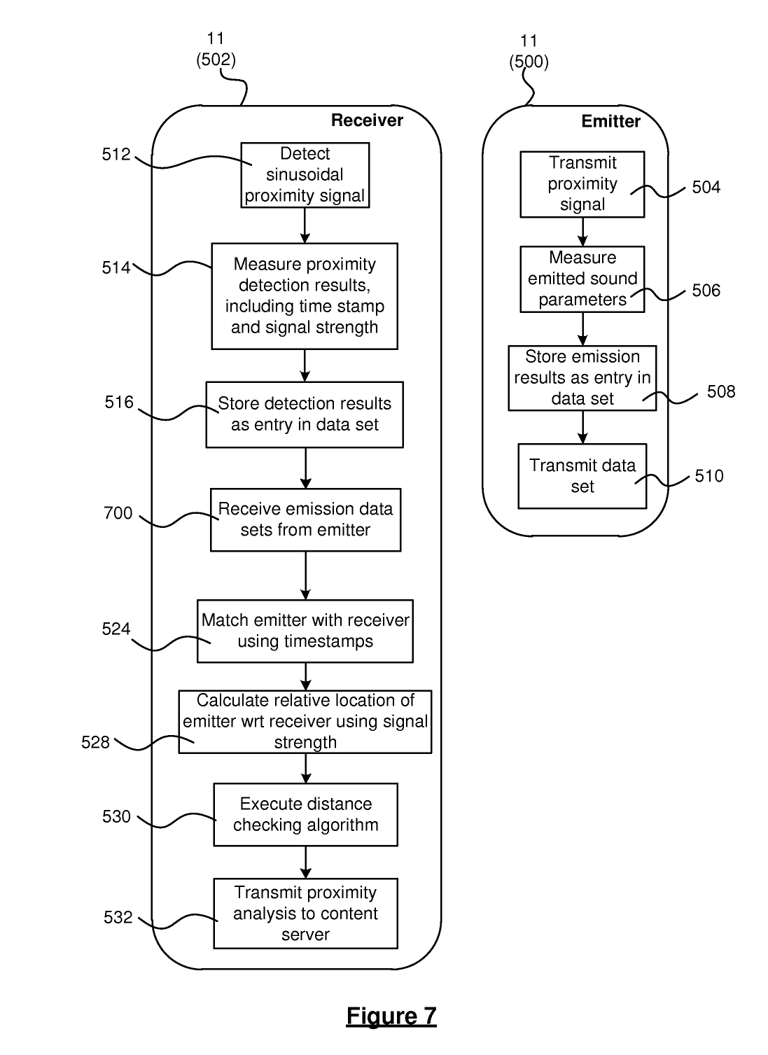

FIG. 7 shows a high level Nock diagram of the operation of the network of user devices 11 according to an alternative embodiment of the invention, this being the embodiment shown in and described above with reference to FIG. 3. In this embodiment, the network server 17 is included within one of the user devices 11. In most respects, operation is the same as described above in relation to FIGS. 3 and 5. However, in this embodiment, the receiving device 502 does not transmit data sets generated by itself for matching and processing remotely. Instead, on receiving a proximity signal the receiving device 502 generates a data set 27 for temporary local storage. The receiving device 502 receives data sets from emitter devices 500. The receiving device 502 matches its internally generated data logs with data sets from the emitter 500 once they are received in step 700.

Numerous positive effects and advantages are provided by the above described embodiments of the invention.

The use of sinusoidal audio transmissions and matching through time stamps provides a relatively simple system. The system may not require any special hardware on the part of the recording devices 11, and the invention may be implemented by firmware or software updates.

These features also allow distance measurements to be performed without the use of closely synchronous clocks at the recording devices, as is required by TDOA systems.

The embodiments also allow a high level of control. For instance, recording devices 11 can be controlled to switch between a proximity signal emission and reception mode and a non-operation mode with a simple control signal. Moreover, this control signal may be broadcast, avoiding the need to address individual devices. Additionally, the regularity (frequency) of emission of proximity signals may be controlled from a central location, for instance the network server, to be increased, decreased, or take a particular setting. This may be achieved by a broadcast signal or by individual addressing of the recording devices 11.

An effect of the above-described embodiments is the possibility to improve the resultant rendering of multi-user scene capture due to the accurate recording of device location. This can allow an experience that creates a feeling of immersion, where the end user is given the opportunity to listen/view different compositions of the audio-visual scene. In addition, this can provided in such a way that it allows the end user to perceive that the compositions are made by people rather than machines/computers, which typically tend to create quite monotonous content.

In some embodiments, the proximity signal is not of sinusoidal form, but consists of a varying set of frequencies in time. For example, the proximity signal may be a chirp signal, which is a tonal signal that changes in frequency over time. Alternatively the proximity signal may be constant in time but with multiple frequencies (for example, 19 kHz and 22 kHz), or any other meaningful combination. The signal includes multiple tonal signals at different frequencies. In these embodiments, the receiver is aware of the nature of the proximity signal and then decides whether the signal was detected and to which degree it matches the ideal proximity signal. The measure of the degree of matching is then used in place of the strength value discussed above. Both a degree of matching and a ‘pure’ signal strength value can be considered to be measures of received signal strength, although in the degree of matching this is a complex measure involving measures of signal strengths at multiple static frequencies or a measure of signal strength of a signal that is changing in frequency.

The invention is not limited to the above-described embodiments and various alternatives will be envisaged by the skilled person and are within the scope of this invention, unless specifically precluded by the claims.

For instance, although in the above the emitter and receiver data sets include both start and end timestamps, this may not be essential. For instance, only one timestamp may be included in each data set. In this case, the timestamp may relate to the start of the sinusoidal signal (either the start of emission or the start or reception), the mid point of the sinusoidal signal, the end point, or some other point.

Also, in the above embodiments the emitters 11 emit proximity signals at a power level or volume that is common to all emissions. This simplifies calculations in distance determination. In other embodiments, the emitter data sets also indicate a emission power or volume. In these embodiments, the emission power is used in the calculation of distance along with the received signal strength.

1-68. (canceled)

69. A method of estimating a distance between a first device and a second device, the method comprising the second device:
detecting an audio signal emitted by the first device;
measuring a strength of the audio signal; and
using the measured signal strength to estimate a distance between the first and second devices.

70. The method of claim 69, wherein detecting an audio signal comprises detecting a sinusoidal audio signal emitted by the first device at a specific frequency.

71. The method of claim 70, wherein detecting a sinusoidal audio signal comprises detecting using the Goertzel algorithm.

72. The method of claim 69, wherein detecting an audio signal comprises detecting a tonal signal with a frequency that varies with time.

73. The method of claim 69, wherein detecting an audio signal comprises detecting an audio signal with tonal content at plural frequencies.

74. The method of claim 69, further comprising mapping distance to a textual location.

75. The method of claim 69, comprising refraining from using the measured signal strength to estimate a distance between the first and second devices when signal strength is below a threshold signal strength.

76. The method of claim 69, comprising using measured signal strength from signals transmitted in both directions between the first and second devices to estimate the distance between the devices.

77. The method of claim 76, comprising using the highest measured signal strength from signals transmitted in both directions between the first and second devices to estimate the distance between the devices.

78. A method as claimed in claim 69, wherein using the measured signal strength to estimate a distance between the first and second devices comprises:
storing first and second collections of data sets, each of the data sets of the first collection comprising an emission time stamp, each of the data sets of the second collection comprising a reception time stamp and data indicative of the measured received signal strength;
using emission time stamps and reception time stamps of the data sets to identify a data set of the first collection that corresponds to a data set of the second collection; and
using the data indicative of the signal strength from the identified data set of the second collection to estimate the distance between the first and second devices.

79. Apparatus, the apparatus having at least one processor and at least one memory having computer-readable code stored therein which when executed controls the at least one processor to:
detect an audio signal emitted by the first device;
measure a strength of the audio signal; and
use the measured signal strength to estimate a distance between the first and second devices.

80. Apparatus as claimed in claim 79, wherein the computer-readable code when executed controls the at least one processor to detect an audio signal, wherein the sinusoidal audio signal emitted by the first device is at a specific frequency.

81. Apparatus as claimed in claim 80, wherein the computer-readable code when executed controls the at least one processor to detect a sinusoidal audio signal using the Goertzel algorithm.

82. Apparatus as claimed in claim 79, wherein the computer-readable code when executed controls the at least one processor to detect an audio signal, wherein the audio signal is a tonal signal with a frequency that varies with time.

83. Apparatus as claimed in claim 79, wherein the computer-readable code when executed controls the at least one processor to detect an audio signal, wherein the audio signal comprises tonal content at plural frequencies.

84. Apparatus as claimed in claim 79, wherein the computer-readable code when executed controls the at least one processor to map distance to a textual location.

85. Apparatus as claimed in claim 79, wherein the computer-readable code when executed controls the at least one processor to refrain from using the measured signal strength to estimate a distance between the first and second devices when signal strength is below a threshold signal strength.

86. Apparatus as claimed in claim 79, wherein the computer-readable code when executed controls the at least one processor to use measured signal strength from signals transmitted in both directions between the first and second devices to estimate the distance between the devices.

87. Apparatus as claimed in claim 86, wherein the computer-readable code when executed controls the at least one processor to use the highest measured signal strength from signals transmitted in both directions between the first and second devices to estimate the distance between the devices.

88. Apparatus as claimed in claim 79, wherein the computer-readable code when executed controls the at least one processor to use the measured signal strength to estimate a distance between the first and second devices, further controls the at least one processor to:
store first and second collections of data sets, each of the data sets of the first collection comprising an emission time stamp, each of the data sets of the second collection comprising a reception time stamp and data indicative of the measured received signal strength;
use emission time stamps and reception time stamps of the data sets to identify a data set of the first collection that corresponds to a data set of the second collection; and
use the data indicative of the signal strength from the identified data set of the second collection to estimate the distance between the first and second devices.

89. A non-transitory computer-readable storage medium having stored thereon computer-readable code, which, when executed by computing apparatus, causes the computing apparatus to perform a method comprising:
detecting an audio signal emitted by the first device;
measuring a strength of the audio signal; and
using the measured signal strength to estimate a distance between the first and second devices.

90. A non-transitory computer-readable storage medium as claimed in claim 89 wherein the computer-readable code when executed by computing apparatus causes the computing apparatus to detect an audio signal emitted by the first device at a specific frequency.

91. A non-transitory computer-readable storage medium as claimed in claim 90 wherein the computer-readable code when executed by computing apparatus causes the computing apparatus to detect a sinusoidal audio signal using the Goertzel algorithm.
